(19) United States
(12) Patent Application Publication
(10) Pub. No.: US 2007/0151822 A1
(43) Pub. Date: Jul. 5, 2007

(54) WET-TYPE MULTI-PLATE CLUTCH

(75) Inventors: Ritsuo Toya, Fukuroi-shi (JP); Shun Kitahara, Fukuroi-shi (JP)

Correspondence Address: MILES & STOCKBRIDGE PC, 1751 PINNACLE DRIVE, SUITE 500, MCLEAN, VA, 22102-3833, US

(73) Assignee: NSK-WARNER K.K.

(21) Appl. No.: 11/608,653

(22) Filed: Dec. 8, 2006

(30) Foreign Application Priority Data
Dec. 8, 2005 (JP) 2005-354897

(51) Int. Cl. F16D 13/00; F16D 13/60

(52) U.S. Cl. 192/70.14; 192/107 M

(57) ABSTRACT

The present invention provides a wet-type multi-plate clutch subjected to slip control, wherein a first friction material including rich diatom earth at its friction surface acting during the slip control and a second friction material acting at completion of engagement and having great static coefficient of friction are stuck on the same surface of a friction plate of the wet-type multi-plate clutch and wherein the first friction material has an axial thickness greater than that of the second friction material.

### BACKGROUND OF THE INVENTION

1. Field of the Invention

The present invention relates to a wet-type multi-plate clutch used as a lock-up clutch or a starting clutch which is used for a torque converter of an automatic transmission and which is subjected to slip control, wherein vibration (judder) caused by stick slip generated in a slipping condition upon engagement can be prevented and a great capacity upon completion of the engagement can be attained.

2. Description of the Related Art

In a lock-up clutch of a torque converter used in an automatic transmission, recently, in order to reduce fuel consumption, lock-up has been operated from an area where a vehicle speed is low. In this case, in order to absorb vibration of an engine during the low vehicle speed, slip control of the lock-up clutch is performed.

Further, in a case where a wet-type multi-plate clutch is used in a starting clutch or the like, slip-control of the multi-plate clutch is used upon starting of the vehicle at a very low speed and upon stopping of the vehicle on a slope road.

In the initiation of the engagement and in the slip control, a friction material which does not generate judder and which has an excellent μ-V property is requested.

Further, during the complete engagement, a friction material having high static coefficient of friction which prevents the slip is requested. Additionally, in the wet-type multi-plate clutch, during an idle rotation in which torque is not transmitted, a multi-plate clutch having low drag in which seizure between plates is hard to be occurred is requested.

In the slipping condition, a friction material which does not generate the judder is requested, and, upon the completion of the engagement, a friction material having the greater torque capacity is requested. However, performances of these two friction materials are contrary to each other, and, therefore, it is feared that, if the performance of one of the friction materials is enhanced, the performance of the other friction material is worsened. As to the property of the friction material, if the property of the friction material, generally, if the static coefficient of friction is increased, the p-V property is worsened (dynamic coefficient of friction becomes to have positive gradient), with the result that the judder may be caused more easily. Further, in the slipping condition, great heat may be generated due to friction heat.

As an example in which different friction materials are stuck, Japanese Patent Application Laid-open No. 63-297832 discloses friction plates having different friction materials. However, in such a friction plate, the friction could not satisfy all of the requirements regarding prevention of the judder, the torque capacity at completion of engagement and heat resistance, and, thus, was not adequate for a multi-plate clutch used in the slip control.

Accordingly, an object of the present invention is to provide a wet-type multi-plate clutch which can prevent vibration (judder) caused by stick slip generated in a slipping condition upon engagement and which has a great torque capacity at completion of the engagement.

### SUMMARY OF THE INVENTION

To achieve the above object, the present invention provides a wet-type multi-plate clutch subjected to slip control, wherein a first friction material including rich diatom earth at its friction surface acting during the slip control and a second friction material acting at completion of engagement and having great static coefficient of friction are stuck on the same surface of a friction plate of the wet-type multi-plate clutch and wherein the first friction material has an axial thickness greater than that of the second friction material.

Further, the present invention provides a wet-type multi-plate clutch subjected to slip control, wherein a first friction material including rich diatom earth at its friction surface acting during the slip control is stuck on an internal tooth plate of the wet-type multi-plate clutch and a second friction material acting at completion of engagement and having great static coefficient of friction is stuck on a surface of an external tooth plate opposed to the internal tooth plate and wherein the first friction material has an axial thickness greater than that of the second friction material.

Further, the present invention provides a wet-type multi-plate clutch subjected to slip control, wherein first friction materials including rich diatom earth at their friction surfaces acting during the slip control are stuck on internal and external tooth plates and second friction materials acting at completion of engagement and having great static coefficient of friction are stuck on a surface or surfaces of the external tooth plate and/or the internal tooth plate opposed to each other and wherein the first friction material has an axial thickness greater than that of the second friction material.

According to the present invention as mentioned above, the following advantages can be obtained.

By sticking the friction material adapted to be used in the slipping condition and hard to generate the judder and the friction material having the great engagement torque capacity at the completion of the engagement, a wet-type multi-plate clutch having a high capacity and. low drag, which has excellent durability and which can prevent the judder, can be provided.

As the friction material adapted to be used in the slipping condition and hard to generate the judder, since the friction material including rich diatom earth at its friction surface has the thickness greater than that of the friction material acting at the completion of the engagement and having the great static coefficient of friction, during the slip control, the friction material adapted to be used in the slipping condition and hard to generate the judder is operated, thereby permitting smooth torque transmission. In the complete engagement, if a greater force is applied by a piston, both of the friction material adapted to be used in the slipping condition and hard to generate the judder and the friction material having the great static coefficient of friction are operated, thereby permitting the transmission of greater torque.

Further, by designing so that friction heat generated in the friction material hard to generate the judder during the slip control is escaped toward the external tooth plate having the great heat capacity, a disadvantage of heat resistance of the friction material hard to generate the judder can be covered. In the course of the completion of the engagement, by designing so that smaller friction heat generated in the friction material having the greater engagement torque capacity is transmitted to the internal tooth plate smaller than the external tooth plate, the heat generated in the friction surface can be dispersed effectively in accordance with the respective conditions.

As a result, a heat-resistive multi-plate clutch which does not generate the judder and which has a high capacity can be provided as a wet-type multi-plate clutch used in the slip control. Further, by arranging the friction material hard to generate the judder during the slip control at an inner diameter side, lubricating oil from the inner diameter side is trapped in an oil reservoir provided by the outer friction material, with the result that more efficient lubrication on the friction surface in the slip condition can be achieved, thereby providing smooth slip control and heat resistance.

By generating oil pressure, the oil pressure can contribute to prevention of the seizure of the plates and reduction of idle rotation drag. Further, such a multi-plate clutch is suitable for applying to a wet-type multi-plate lock-up clutch used in a torque converter or a starting clutch.

Further features of the present invention will become apparent from the following description of exemplary embodiments with reference to the attached drawings.

### BRIEF DESCRIPTION OF THE DRAWINGS

FIG. 1 is a partial axial sectional view of a torque converter apparatus including therein a wet-type multi-plate lock-up clutch applicable to the present invention.

FIGS. 2A and 2B are views showing a friction plate. according to a first embodiment of the present invention, where FIG. 2A is a partial front view of the friction plate and FIG. 2B is a partial sectional view taken along the line 2B-2B in FIG. 2A.

FIGS. 3A and 3B are views showing a friction plate according to a second embodiment of the present invention, where FIG. 3A is a partial front view of the friction plate and FIG. 3B is a partial sectional view taken along the line 3B-3B in FIG. 3A.

FIGS. 4A and 4B are views showing a friction plate according to a third embodiment of the present invention, where FIG. 4A is a partial front view of the friction plate and FIG. 4B is a partial sectional view taken along the line 4B-4B in FIG. 4A.

FIG. 5 is sectional view showing a wet-type multi-plate clutch according to a fourth embodiment of the present invention.

FIG. 6 is a partial front view of an external tooth plate of FIG. 5.

FIG. 7 is a partial front view of an internal tooth plate of FIG. 5.

FIG. 8 is a partial front view showing an alteration of the external tooth plate.

FIG. 9 is a partial front view showing an alteration of the internal tooth plate.

### DESCRIPTION OF THE EMBODIMENTS

Now, embodiments of the present invention will be explained with reference to the accompanying drawings. Incidentally, in the drawings, the same parts or elements are designated by the same reference numerals. Further, it should be noted that embodiments are merely examples of the present invention and do not limit the present invention in all means.

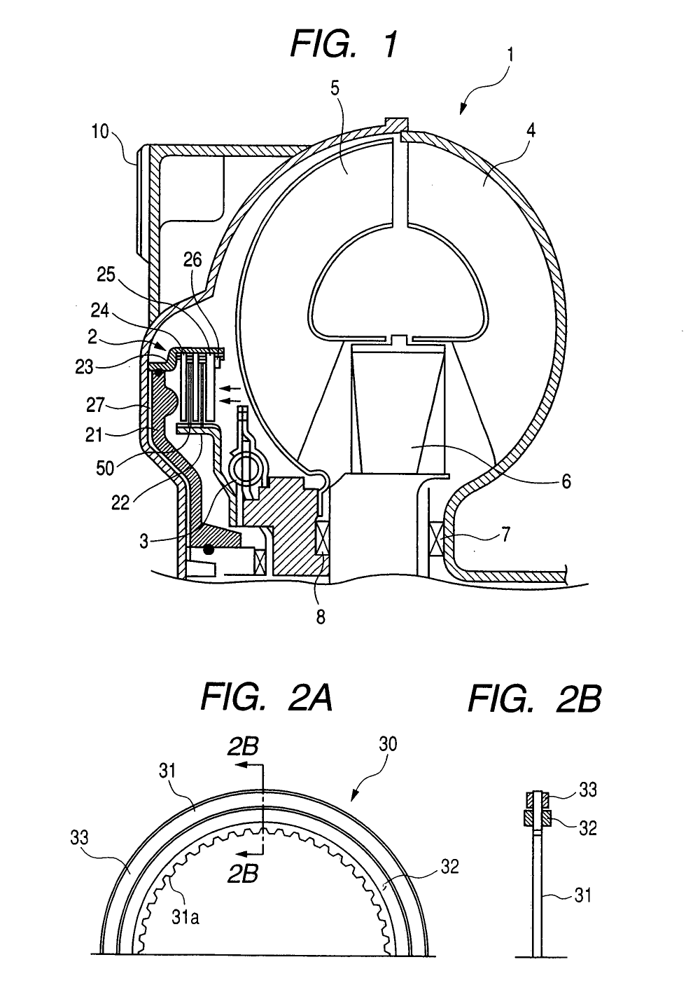

FIG. 1 is a partial axial sectional view of a converter apparatus including therein a wet-type multi-plate lock-up clutch applicable to the present invention. The torque converter apparatus 1 is constituted by a wet-type multi-plate lock-up clutch 2, a damper 3, pump vane wheels 4, turbine vane wheels 5 and a stator 6. Both axial ends of the stator 6 are supported by needle bearings 7 and 8, and a one-way clutch (not shown) for preventing a reverse rotation regarding a predetermined direction is provided on an inner periphery of the stator.

Further, in the wet-type multi-plate lock-up clutch 2, separator plates 24 and a packing plate 25 fitted onto an inner periphery of a clutch case 23 via splines, and friction plates 50 fitted onto an outer periphery of a hub 22 are alternately arranged along an axial direction and are supported by a snap ring 26. Further, a piston 21 is disposed at the left side (FIG. 1) of these plates, and, when oil pressure is supplied to a hydraulic chamber 27, the piston 21 is shifted to the right (FIG. 1), with the result that the separator plates 24, friction plates 50 and packing plate 25 are pinched between the piston and the snap ring 26, thereby establishing a tightening condition, i.e. an engagement condition.

Although the wet-type multi-plate clutch of the present invention can be used with a converter apparatus having an arrangement shown in FIG. 1, it should be noted that the wet-type multi-plate clutch can be applied to a starting clutch and the like.

### FIRST EMBODIMENT

FIGS. 2A and 2B are views showing a friction plate according to a first embodiment of the present invention. FIG. 2A is a partial front view of the friction plate and FIG. 2B is a partial sectional view taken along the line A-A in FIG. 2A.

The friction plate 30 is constituted by sticking first and second friction materials onto a substantially annular core plate 31 made of steel. The core plate 31 is provided at its inner periphery with splines and is fitted to a rotary member (not shown).

On each of friction surfaces at both axial directions of the core plate 31, a substantially first annular friction material 32 is stuck at an inner diameter side and a substantially annular second friction material 33 is stuck at an outer diameter side. The first friction material 32 and the second friction material 33 are disposed adjacent to each other in a radial direction.

As can be seen from FIG. 2B, the first friction material 32 has an axial thickness greater than that of the second friction material 33. Further, the first friction material 32 is adapted to be operated from the initiation of the slip control to the completion of engagement and is formed from a material including rich diatom earth, and the second friction material 33 is adapted to be operated mainly at the completion of the engagement and is formed from a material having great static coefficient of friction.

That is to say, in the slip control at the initial stage of the engagement, the first friction material 32 using the friction material adapted to be used in the slipping condition and hard to generate the judder is operated, and, upon the completion of the engagement, in addition to the first friction material 32, the second friction material 33 having the great static coefficient of friction is also operated. As a result, greater torque can be transmitted.

### SECOND EMBODIMENT

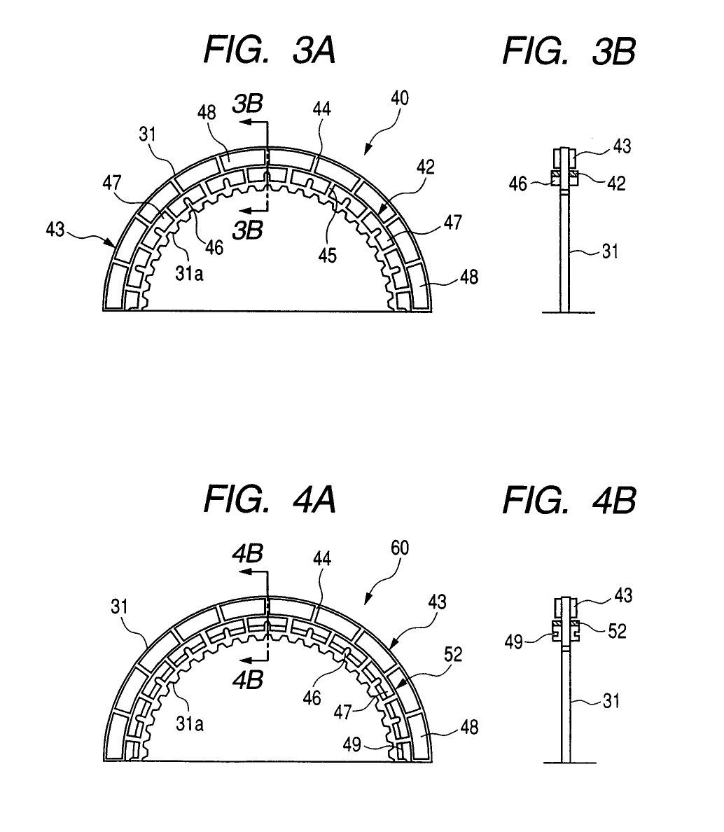

FIGS. 3A and 3B are views showing a friction plate according to a second embodiment of the present invention. FIG. 3A is a partial front view of the friction plate and FIG. 3B is a partial sectional view taken along the line B-B in FIG. 3A.

Similar to the first embodiment, a friction plate 40 is constituted by sticking first and second friction materials onto a substantially annular core plate 31 made of steel. The core plate 31 is provided at its inner periphery with splines 31a and if fitted on a rotary member (not shown).

On each of both axial friction surfaces of the core plate 31, the first friction material 42 is stuck at an inner diameter side and the second friction material 43 is stuck at an outer diameter side by adhesives. The first friction material 42 and the second friction material 43 are disposed adjacent to each other in a radial direction.

In the first embodiment, while the first and second friction materials are substantially annular and have circumferential continuous friction surfaces, in the second embodiment, each of the first friction material 42 and the second friction material 43 comprises a plurality of friction material segments disposed at a predetermined interval along a circumferential direction. That is to say, the first friction material 42 includes a plurality of friction material segments 47 and the second friction material 43 also includes a plurality of friction material segments 48.

As can be seen from FIG. 3B, the first friction material segment 47 has an axial thickness greater than that of the second friction material segment 48. Further, each of the first friction material segments 47 is adapted to be operated from the initiation of the slip control to the completion of engagement and is formed from a material including rich diatom earth, and each of the second friction material segments 48 is adapted to be operated mainly at the completion of the engagement and is formed from a material having great static coefficient of friction.

Similar to the first embodiment, in the slip control at the initial stage of the engagement, the first friction material segments 47 using the friction material adapted to be used in the slipping condition and hard to generate the judder are operated, and, upon the completion of the engagement, in addition to the first friction material segments 47, the second friction material segments 48 having the great static coefficient of friction are also operated. As a result, greater torque can be transmitted.

In the first friction material segment 47, a radial groove 46 which terminates at substantially middle point of the segment in the radial direction and is opened to the inner diameter side is provided at a substantially middle area of the segment in the circumferential direction. Further, a space or clearance 45 is provided between the adjacent first friction material segments 47. A plurality of the spaces 45 formed along the circumferential direction serve as oil passages for lubricating oil.

Further, a space or clearance 44 is formed between the adjacent second friction material segments 48. A plurality of the spaces 44 formed along the circumferential direction serve as oil passages for the lubricating oil. The spaces 44 and 45 have substantially the same circumferential widths. Further, as shown in FIG. 3A, the spaces 44 and 45 are staggered along the circumferential direction, and, thus the spaces 44 and 45 are not opposed to each other.

According to this embodiment, since the groove-shaped spaces 44 and 45 act as the lubricating oil passages, the drag can be reduced by lubrication at the inner diameter portion and a plate separating effect during the idle rotation.

### THIRD EMBODIMENT

FIGS. 4A and 4B are views showing a friction plate according to a third embodiment of the present invention. FIG. 4A is a partial front view of the friction plate and FIG. 4B is a partial sectional view taken along the line C-C in FIG. 4A.

A third embodiment is fundamentally similar to the second embodiment, and, thus, only differences will be described. In the third embodiment, a construction of a first friction material 52 differs from that of the friction material of the second embodiment. In the first friction material, plural friction material segments 47 are stuck on the friction surface of the core plate 31 at a predetermined interval along a circumferential direction.

Each first friction material segment 47 is provided at its surface with a circumferential groove 49 extending in the circumferential direction. The circumferential groove 49 intersects with the groove 46 and the spaces 45 to be communicated with them. As shown in FIG. 4B, similar to the first and second embodiments, the first friction material 52 has an axial thickness greater than that of the second friction material 43.

According to this embodiment, by providing the circumferential grooves, an effect in which judder is more hard to generate during the slipping condition can be obtained.

### FOURTH EMBODIMENT

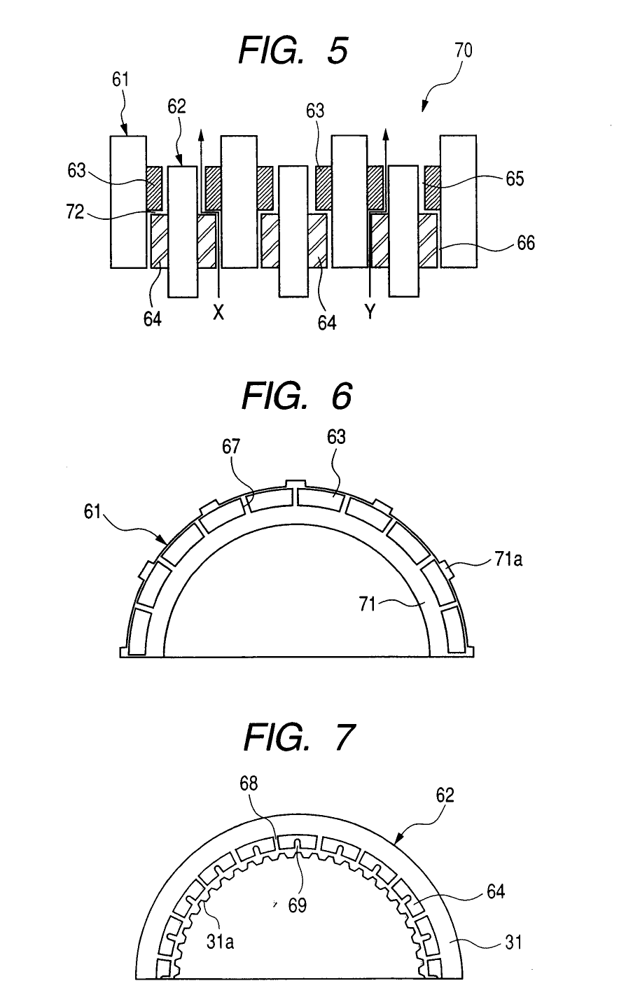

FIG. 5 is a sectional view of a wet-type multi-plate clutch according to a fourth embodiment of the present invention, and FIG. 6 is a partial front view of an external tooth plate and FIG. 7 is a partial front view of an internal tooth plate.

FIG. 5 shows a condition that the wet-type multi-plate clutch is performing the idle rotation. The wet-type multi-plate clutch 70 includes plural external tooth plates 61 and plural internal tooth plates 62 which are arranged alternately in an axial direction. Here, the outer tooth plates 61 act as friction plates and the internal tooth plates act as separator plates.

Each of the external tooth plates 61 is constituted by sticking second friction material segments 63 on one surface or both surfaces of a substantially annular core plate 71 provided at its outer periphery with a plurality of projections 71a. As shown in FIG. 6, the second friction material segments 63 are arranged annularly and equidistantly along a circumferential direction so that a clearance or space 67 acting as an oil passage is formed between the adjacent segments. The second friction material segments 63 are offset toward an outer diameter side of the external tooth plate 61 and are fixed thereto.

On the other hand, first friction material segments 64 are stuck onto one surface or both surfaces of the internal tooth plate 62. As shown in FIG. 7, the first friction material segments 64 are arranged annularly and equidistantly along a circumferential direction so that a clearance or space 68 acting as an oil passage is formed between the adjacent segments. The first friction material segments 64 are offset toward an inner diameter side of the internal tooth plate 62 and are fixed thereto. Further, a radial groove 69 terminating at a substantially middle point of the first friction material segment in a radial direction and opened to an inner diameter side of the segment is formed in the first friction material segment 64 at its central portion in the circumferential direction.

Now returning to FIG. 5, although the external tooth plates 61 and the internal tooth plates 62 are arranged alternately along the axial direction, as mentioned above, since the second friction material segments 63 of the external tooth plates 61 and the first friction material segments 64 of the internal tooth plates 62 are offset from each other in the radial direction with the interposition of a predetermined clearance 72, the friction material segments are not contacted with each other.

Further, similar to the first to third embodiments, each of the first friction material segments 64 provided at the inner diameter side has an axial thickness greater than that of each second friction material segment 63 provided at the outer diameter side. Accordingly, from the idle rotation condition shown in FIG. 5, when the external tooth plates 61 and the internal tooth plates 62 approach each other, firstly, the first friction material segments 64 are contacted with the external tooth plates 61, thereby starting the slipping condition.

Thereafter, when external tooth plates 61 and the internal tooth plates 62 further approach each other, the second friction material segments 63 provided at the outer diameter side begin to contact with the internal tooth plates 62, thereby starting the engagement completion condition. Accordingly, upon the tightening, i.e. completion of the engagement of the wet-type multi-plate clutch 70, the second friction material segments 63 is engaged by the internal tooth plates 61 and the first friction material segments 64 are engaged by the external tooth plates 62.

Since the first friction material segments 64 stuck to the internal tooth plate 62 are operated during the slip control, each first segment is formed from a material including rich diatom earth, whereas, since the second friction material segments 63 stuck to the external tooth plate 61 are operated upon the completion of the engagement, each second segment is formed from a material having great static coefficient of friction.

In FIG. 5 showing the idle rotation condition, an axial clearance or gap 72 is defined between the second friction material segment 63 and the first friction material segment 64, and a clearance 65 extending in the radial direction is defined between the second friction material segment 63 and the internal tooth plate 62, and a clearance 66 extending in the radial direction is defined between the first friction material segment 64 and the external tooth plate 61.

Three clearances 65, 66 and 72 are communicated with each other to define a lubricating oil passage. By such lubricating oil passages, two. lubricating oil flows shown by the arrows X and Y in FIG. 5 are provided. Accordingly, in a disengagement condition of the wet-type multi-plate clutch 70, i.e. in the idle rotation condition, the lubricating oil flows along the arrows X and Y from the inner diameter side to the outer diameter side, thereby lubricating the clutch portion.

The three clearances 65, 66 and 72 serve as an oil reservoir trapping the lubricating oil during the slipping condition. By the oil trapped in the oil reservoir and the flows of the lubricating oil flowing along the arrows X and y, an effect for separating the plates during the idle rotation can be obtained, thereby reducing the drag.

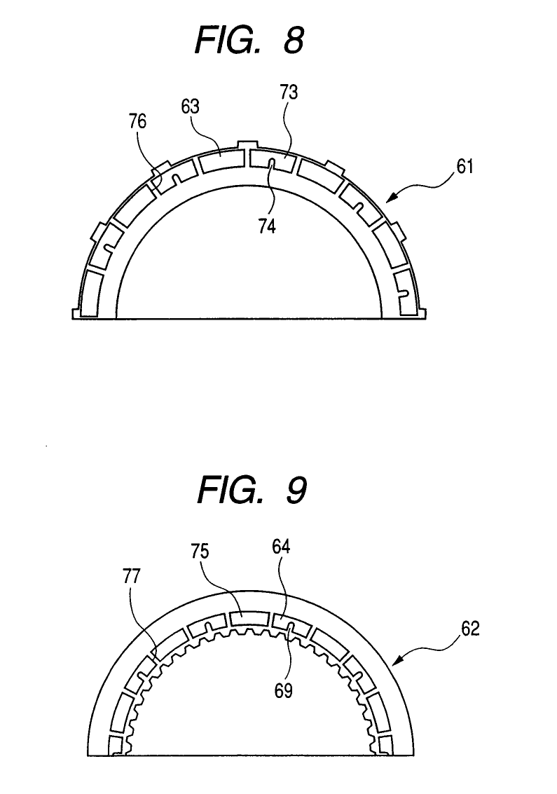

FIGS. 8 and 9 show an alteration of the fourth embodiment, where FIG. 8 is a partial front view showing an alteration of the external tooth plate 61 and FIG. 9 is a partial front view showing an alteration of the internal tooth plate 62.

As shown in FIG. 8, not only the second friction material segments 63 of FIG. 6 but also second friction material segments 73 are stuck onto the external tooth plate 61. The second friction material segments 63 and the second friction material segments 73 are arranged alternately along a circumferential direction with the interposition of a clearance 76. Further, a radial groove 74 opened to an inner diameter side is previously formed in each of the second friction material segments 73 by cutting or punching.

Next, as shown in FIG. 9, not only the first friction material segments 64 of FIG. 7 but also second friction material segments 75 are stuck on the internal tooth plate 62. The first friction material segments 64 and the second friction material segments 75 are arranged alternately along a circumferential direction with the interposition of a clearance 77.

The friction materials stuck to the external tooth plate 61 and the internal tooth plate 62 are frictionally engaged by core plates of the opposed plates. By sticking the friction materials for the slip control on the external tooth plate 61 and the internal tooth plate 62, friction heat generated by the sliding movements with the mating friction materials is thermally dispersed into both plates, thereby preventing thermal deterioration of the friction materials.

The second friction material segments 63 having the great static coefficient of friction at the completion of the engagement may be stuck onto only one surface of the external tooth plate 61 or may be stuck onto both surfaces as shown in FIG. 5. Further, in the embodiments shown in FIGS. 3 to 9, while an example that both friction materials provided at the outer diameter side and the inner diameter side are constituted by the friction material segments were explained, in place of the friction material segments, a continuous annular friction material may be stuck. Further, a combination in which friction material segments are used at the outer peripheral side and an annular friction material is used at the inner peripheral side or vice versa may be adopted.

In a case where the annular friction material is used, oil grooves may be formed in a surface of the friction material by deformation processing using a press or by cutting.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent No. 2005-354897, filed Dec. 8, 2005, which is hereby incorporated by reference herein in its entirety.

What is claimed is:

1. A wet-type multi-plate clutch subjected to slip control, wherein:
a first friction material including rich diatom earth at its friction surface acting during the slip control and a second friction material acting at completion of engagement and having great static coefficient of friction are stuck on the same surface of a friction plate of said wet-type multi-plate clutch, and said first friction material has an axial thickness greater than that of said second friction material.

2. A wet-type multi-plate clutch subjected to slip control, wherein:
a first friction material including rich diatom earth at its friction surface acting during the slip control is stuck on an internal tooth plate of said wet-type multi-plate clutch and a second friction material acting at completion of engagement and having great static coefficient of friction is stuck on a surface of an external tooth plate opposed to said internal tooth plate, and said first friction material has an axial thickness greater than that of said second friction material.

3. A wet-type multi-plate clutch subjected to slip control, wherein:
first friction materials including rich diatom earth at their friction surfaces acting during the slip control are stack on internal and external tooth plates and second friction materials acting at completion of engagement and having great static coefficient of friction are stuck on surface or surfaces of said external tooth plate and/or said internal tooth plate opposed to each other, and said first friction material has an axial thickness greater than that of said second friction material.

4. A wet-type multi-plate clutch according to claim 1, wherein said first friction material is stuck at more inner diameter side than said second friction material.

5. A wet-type multi-plate clutch according to claim 2, wherein said first friction material is stuck at more inner diameter side than said second friction material.

6. A wet-type multi-plate clutch according to claim 1, wherein a circumferential groove is provided in said first friction material.

7. A wet-type multi-plate clutch according to claim 1, wherein at least one of said first friction material and said second friction material is constituted by friction material segments.
